(19) United States
(12) Patent Application Publication
(10) Pub. No.: US 2024/0363831 A1
(43) Pub. Date: Oct. 31, 2024

(54) LITHIUM RECHARGEABLE BATTERIES

(71) Applicants: Ryan Redford, Irvine, CA (US); Daniel Carothers, Lucas, TX (US)

(72) Inventors: Ryan Redford, Irvine, CA (US); Daniel Carothers, Lucas, TX (US)

(21) Appl. No.: 18/445,071

(22) PCT Filed: Sep. 28, 2021
(86) PCT No.: PCT/US2021/052460

§ 371 Date: Mar. 29, 2023

Related U.S. Application Data
(60) Provisional application No. 63/085,081, filed on Sep. 29, 2020.

(51) Int. Cl. H01M 4/134; H01M 4/02; H01M 10/0525; H01M 10/0568

(52) U.S. Cl. CPC H01M 4/134; H01M 10/0525; H01M 2004/021; H01M 2004/027; H01M 10/0568

(57) ABSTRACT

A lithium ion battery, has a cathode electrode; an anode electrode formed of a porous silicon substrate in which surfaces of the pores of the porous silicon substrate are coated at least in part with a metal silicide; a separator element disposed between the cathode and the anode; and an electrolyte.

The demand for high capacity rechargeable batteries is strong and increasing each year. Many applications, such as aerospace, medical devices, portable electronics, and automotive applications, require high gravimetric and/or volumetric capacity cells. Lithium ion electrode technology can provide significant improvements in this area. However, to date, lithium ion cells employing graphite electrodes are limited to theoretical specific energy density of only 372 mAh/g.

Silicon is an attractive active electrode for use in lithium ion batteries material because of its high electrochemical capacity. Silicon has a theoretical capacity of about 4200 mAh/g, which corresponds to the Li_{4.4}Si phase. Yet, silicon is not widely used in commercial rechargeable lithium ion batteries. One reason is that silicon exhibits substantial changes in volume during charging and discharging cycling. For example, silicon may swell by as much as 400% when charged to its theoretical capacity. Volume changes of this magnitude can cause substantial stresses in the active material structures, resulting in fractures and pulverization, loss of electrical and mechanical connections within the electrode, and capacity fading.

Conventional rechargeable lithium ion battery electrodes typically include polymer binders that are used to hold active materials on a carbon or graphite substrate. However, most polymer binders are not sufficiently elastic to accommodate the large swelling of some high capacity materials. As a result, active material particles tend to separate from each other and the current collector. Overall, there is a need for improved applications of high capacity active materials in rechargeable lithium ion battery electrodes that minimize the drawbacks described above.

U.S. Pat. Nos. 8,257,866 and 8,450,012 propose addressing the elasticity and swelling problems of prior art rechargeable lithium ion battery electrode materials by providing an electrochemically active electrode material comprising a high surface area template containing a metal silicide and a layer of high capacity active material deposited over the template. The template reportedly serves as a mechanical support for the active material and/or an electrical conductor between the active material and, for example, the substrate. According to the inventors, due to the high surface area of the template, even a thin layer of the active material can provide sufficient active material loading and corresponding electrode capacity per surface area. As such, the thickness of the active material layer theoretically may be maintained sufficiently small to be below its fracture threshold to preserve its structural integrity during battery cycling. The thickness and/or composition of the active layer also may be specifically profiled to reduce swelling near the substrate interface and preserve the interface connection.

In order to overcome the aforesaid and other problems in the prior art, we provide high surface area porous silicon substrate materials for forming anode electrodes for rechargeable lithium ion batteries. More particularly, in accordance with the present disclosure, silicon substrate material is subjected to an electrochemical etching to form interconnected nanostructures or through holes or pores through the silicon substrate material. Thereafter, an electrochemically active material such as a metal silicide is formed on surfaces of the pores of the silicon substrate material, for example, by depositing an appropriate metal such as titanium or tungsten on the porous silicon substrate material, using various deposition techniques including but not limited to chemical vapor deposition (CVD), plasma-enhanced chemical vapor deposition (PECVD), thermal CVD, electroplating, electroless plating, and/or solution deposition techniques, which are given as exemplary, and the metal-coating on the porous silicon substrate material is converted to the corresponding metal silicide by heating.

The resulting substrate is a porous silicon substrate which includes a metallurgically bonded surface layer of metal silicide on the walls of the porous structure, which advantageously may be used as an electrode in a rechargeable lithium ion battery.

While the resulting porous substrate material may be somewhat less efficient per charge volume than, for example, conventional carbon or graphite based electrodes used in rechargeable lithium ion batteries, the porous structure provides several significant advantages. For one, the porous structure allows protons more time to move through the electrode matrix. As a result, swelling during a charging cycle is significantly reduced. Thus, the substrate is less likely to form dendrites or fracture during a charging cycle. Accordingly, charge and discharge rates may be increased without a danger of fracture or explosion. Furthermore, when used as an anode, the anode may be made significantly larger than the cathode resulting in further increases in overall performance.

The present disclosure also provides lithium ion batteries, comprising: a cathode electrode; an anode electrode formed of a porous silicon substrate in which surfaces of the pores of the porous silicon substrate are coated at least in part with a metal silicide; a separator element disposed between the cathode and the anode; and an electrolyte. The silicon substrate may comprise monocrystalline silicon, polycrystalline silicon, or amorphous silicon. Preferably the pores have a length to diameter aspect ratio of >50:1, and the electrolyte comprises a conventional lithium salt electrolyte such as LiPF₆ or LiBF₄ in an organic solvent such as vinylene carbonate, 1,3-Propane sultone, 2-Propylmethanesulfate, Cyclohexylbenzene, t-Amylbenzene or Adiponitride which are given as exemplary.

In one embodiment the metal silicide coating is selected from the group consisting of TiSi₂, CoSi₂ and WSi₂ which are given as exemplary.

The present disclosure also provides an electrode for use in a lithium ion battery, wherein the anode electrode comprises a substrate formed of porous silicon in which surface areas of the pores are coated at least in part with a metal silicide. The silicon substrate may comprise monocrystalline silicon, polycrystalline silicon, or amorphous silicon, the pores have a length to diameter aspect ratio of >50:1, and the metal silicide preferably is selected from the group consisting of TiSi₂, CoSi₂ and WSi₂ which are given as exemplary.

Further features and advantages of the present disclosure will be seen from the following detailed description, taken in conjunction with the accompanying drawings, wherein like numeral depict like parts, and wherein

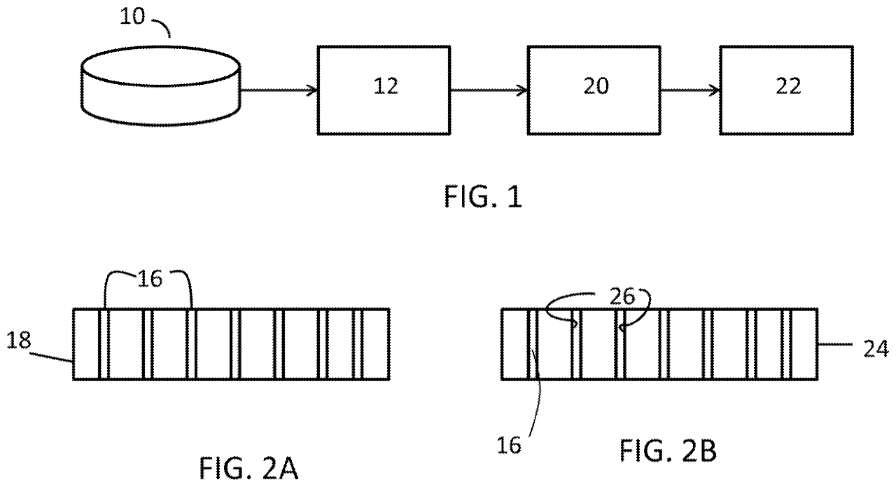

FIG. 1 is a schematic block diagram with a process for producing electrode material in accordance with one embodiment of the present disclosure;

FIGS. 2A and 2B are cross-sectional view of electrode material at various stages of production in accordance with the present disclosure;

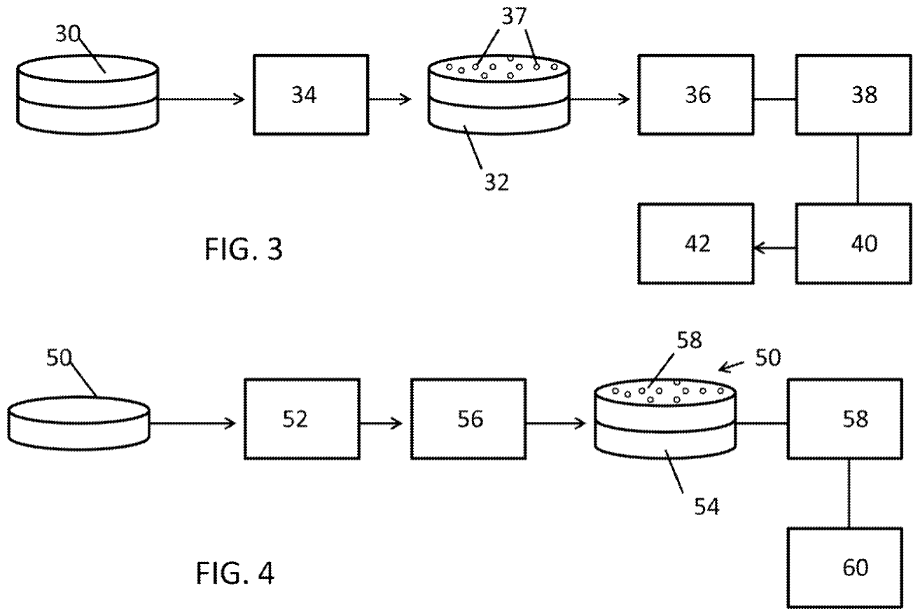

FIG. 3 is a schematic block diagram of a process for producing electrode material in accordance with another embodiment of the present disclosure;

FIG. 4 is a schematic block diagram of a yet another process for producing electrode material in accordance with the present disclosure;

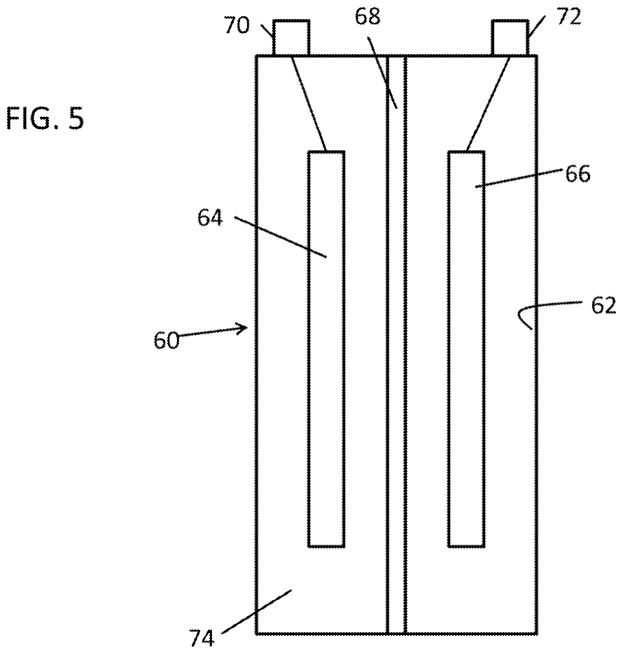

FIG. 5 is a cross-sectional view of a rechargeable battery made in accordance with the present disclosure;

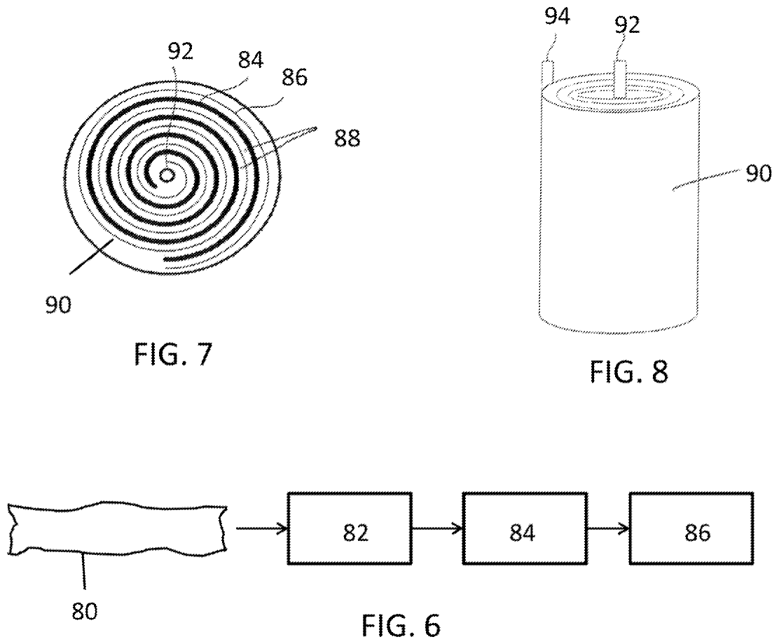

FIG. 6 is a schematic block diagram of still yet another process for producing electrode material in accordance with the present disclosure;

FIG. 7 is a cross-sectional view of a rechargeable battery in accordance with the present disclosure; and

FIG. 8 is a perspective view of a battery made in accordance with the present disclosure.

Referring to FIG. 1, starting with a thin monocrystalline silicon wafer 10, typically 50-200 mil thick, the wafer 10 is subjected to an electrochemical etching by applying uniform electrical field across the wafer while immersing the wafer in an etchant such a Dimethylformamide (DMF)/Dimethylsulfoxide (DMSO)/HF etchant in an electrochemical immersion cell, in an electrochemical etching step 12, to form micron sized through holes or pores 16 through the wafer as shown in FIG. 2A. The growth of well-defined cylindrical micropores or through holes can be controlled by controlling etching conditions, i.e., etching current density, etchant concentration, temperature, silicon doping, etc., following the teachings of Santos et al., Electrochemically Engineered Nanoporous Material, Springer Series in Materials Science 220 (2015), Chapter 1, the contents of which are incorporated herein by reference.

The resulting pores have a high aspect ratio of length to cross-sectional diameter typically a length to diameter aspect ratio of >50:1. The resulting structure, shown in FIG. 2A comprises a porous silicon wafer 18 having substantially cylindrical through holes or pores 16 having a length of, e.g., 180 μm and a diameter of 1.6 μm, i.e, an aspect ratio of 112.5:1 which is quite effective for use as electrode in a lithium ion battery as will be described below. The walls of the resulting porous silicon wafer 18 are then coated with a metal such as titanium or tungsten in step 20, and the metal coated porous silicon wafer is then subjected to a heat treatment in a heating step 22 to convert the deposited metal to the corresponding metal silicide 25 at heat treatment step 22. There results a porous silicon substrate material 24 in which the wall surfaces of the pores of the material are coated with a thin layer of a metal silicide material 26 (FIG. 2A).

FIG. 3 illustrates an alternative embodiment of the present disclosure. The process starts with a silicon wafer 30 to which is applied a thin metal layer 32 on the back side of the wafer 30 e.g., by sputtering in a step 34. Metal layer 32 on the backside of the wafer promotes improved electrical contact to the wafer. An electro chemical etching (step 36) is used to form pores 37 through the silicon wafer 30. After porous silicon formation, a wet etch (step 38) is used to remove the thin metal 32 from the back side. The porous silicon wafer which is similar to the porous silicon substrate shown in FIG. 2A is then coated with metal in step 40 and the metal converted to the silicide in a heating step 42 similar to the first embodiment. There results a porous silicon substrate in which the surface of the wall surfaces of the pores are coated with a metal silicide similar to the porous silicon substrate shown in FIG. 2B.

FIG. 4 illustrates a third embodiment of the present disclosure. The process starts with a silicon wafer 50 covered on one side in step 52 with a sacrificial metal layer 54 formed of, for example, a noble metal such as platinum. The silicon wafer 50 is then subjected to electrochemical etching by applying an uniform electrical field across the metal layer 54 and substrate wafer 50 as the wafer is immersed in an electrochemical cell containing an etchant such as HF and H₂O₂, in step 56, whereby to produce substantially uniform pores 58 through the exposed portion of the silicon wafer substrate 50 to the metal layer 54. As before, the growth of well-defined cylindrical micropores or through holes can be controlled by controlling etching conditions, i.e., etching current density, etching concentration, temperature, silicon doping, etc., again following the teachings of Santos et al. Alternatively, micropore or through hole formation can be controlled by covering selected portions of the silicon wafer with a nanoporous anodic alumina mask. Self-ordered nano porous anodic alumina is basically a nanoporous matrix based on alumina that features closed-packed arrays of hexagonally arranged cells, at the center of which a cylindrical nanopore grows perpendicularly to the underlying aluminum substrate. Nanoporous anodic alumina may be produced by electrochemical anodization of aluminum, again following the teachings of Santos et al. the teachings of which are incorporated herein by reference. The sacrificial metal layer 54 can then be removed in a step 58 leaving a porous silicon wafer having substantially cylindrical through holes or pores having a length to diameter aspect ratio of >50:1, i.e., similar to the porous silicon substrate shown in FIG. 2A. The porous silicon substrate is then coated with metal in step 58, and heated to convert the metal to the metal silicide in step 60, whereby a porous silicon substrate in which the wall surfaces of the pores are coated with metal silicide similar to FIG. 2B is produced.

Porous silicon wafers as produced above are assembled into a lithium ion battery as will be described below.

FIG. 5 shows a lithium ion battery 60 in accordance with the present disclosure. Battery 60 includes a case 62, an anode 64 formed of a metal silicide coated porous silicon substrate formed as above described, and a cathode 66 formed, for example, of graphite, separated by a membrane or separator 68. Anode 64 and cathode 66 are connected respectively, to external tabs 70, 72, respectively. A lithium containing electrolyte 74, for example, lithium cobalt oxide is contained within the battery 60.

Both the anode and cathode allow lithium ions to move in and out of their structures by a process called insertion (intercalation) or extraction (deintercalation), respectively. During discharge, the positive lithium ions move from the negative electrode (anode) to the positive electrode (cathode) forming a lithium compound through the electrolyte while the electrodes flow through the external circuit in the same direction. When the cell is charging, the reverse occurs, with the lithium ions and the electrodes moving back into the negative electrode with a net higher energy stake.

A feature an advantage of the present disclosure is that the anode may be made physically larger, i.e., thicker than the cathode. The increased thickness porous structure of the anode allows protons more time to move into the electrode matrix. Also, less lithium electrolyte is required for similar energy storage. And, since the protons move more slowly into the anode, this permits a faster charge and discharge rate without a danger of fractures or pulverization of the electrode.

Changes may be made in the above disclosure without departing from the spirit and scope thereof. For example, while the anode production has been described as being formed from monocrystalline silicon wafers, monocrystalline silicon ribbon advantageously may be employed for forming the anode. Referring to FIG. 6, employing silicon ribbon 80 permits a continuous process in which ribbon is run through an electrochemical etching bath 82 to form pores through the ribbon, and then from there through a metal coating station 84 and from there a heat treating station 86 to form metal silicide on the surfaces of the walls of the pores. The resultant porous silicon metal silicide coated ribbon may then be used to form a lithium ion battery using standard roll manufacturing techniques. For example, referring to FIG. 7, the silicide coated porous silicon ribbon anode electrode 84 may be assembled in a stack with cathode electrode 86 between separator sheets 88. The electrodes 84, 86 and separator sheets 88 are wound together in a jelly roll and then inserted in a case 90 with a positive tab 92 and negative tab 94 extending from the jelly roll. The tabs may then be welded to an exposed portion of the electrodes 84, 86, the case 90 filled with electrolyte, and the case 90 sealed. There results a high capacity lithium ion rechargeable battery in which the anode material comprises porous metal silicide coated porous silicon ribbon capable of repeated charges and discharges without adverse effects.

Still other changes are possible. For example, rather than using monocrystalline silicon chips or monocrystalline silicon ribbon, the silicon may be polysilicon silicon or amorphous silicon. Also, while tungsten cobalt and titanium have been described as the preferred metals for forming the metal silicides, other conventionally used in forming advantageously may be employed including silver (Ag), aluminum (Al), gold (Au), palladium (Pd), platinum (Pt), Zn, Cd, Hg, B, Ga, In, Th, C, Si, Ge, Sn, Pb, As, Sb, Bi, Se and Te. Also, while LiPF₆ and LiBf₄ has been described as useful electrolytes, other electrolytes conventionally used with lithium ion batteries including but not limited to lithium cobalt oxide (LiCoO₂).

1-13. (canceled)

14. A lithium ion battery, comprising:
a cathode electrode;
an anode electrode formed of a porous silicon substrate in which the pores have a length to diameter aspect ratio of >50:1, and wherein surfaces of the pores of the porous silicon substrate are coated at least in part with a metal silicide;
a separator element disposed between the cathode and the anode; and
an electrolyte.

15. The lithium ion battery of claim 14, wherein the silicon substrate comprises monocrystalline silicon.

16. The lithium ion battery of claim 14, wherein the silicon substrate comprises polycrystalline silicon.

17. The lithium ion battery of claim 14, wherein the silicon substrate comprises amorphous silicon.

18. The lithium ion battery of claim 14, wherein the metal silicide coating is selected from the group consisting of TiSi₂, CoSi₂ and WSi₂.

19. The lithium ion battery of claim 14, wherein the electrolyte is selected from the group consisting of LiPF₆, LiBF₄ and LiCoO₂.

20. An electrode for use in a lithium ion battery, wherein the anode electrode comprises a substrate formed of porous silicon in which the pores have a length to diameter aspect ratio of >50:1, and wherein surface areas of the pores are coated at least in part with a metal silicide.

21. The electrode of claim 20, wherein the silicon substrate comprises monocrystalline silicon.

22. The electrode of claim 20, wherein the silicon substrate comprises polycrystalline silicon.

23. The electrode of claim 20, wherein the silicon substrate comprises amorphous silicon.

24. The electrode of claim 20, wherein the metal silicide is selected from the group consisting of TiSi₂, CoSi₂ and WSi₂.
